(19) United States
(12) Patent Application Publication
(10) Pub. No.: US 2002/0068786 A1
(43) Pub. Date: Jun. 6, 2002

(54) Method of producing mixtures of polyvinyl chloride and polymers based on conjugated dienes and acrylonitrile

(76) Inventors: Rainer Graefe, Rommerskirchen (DE); Paul Krieger, Langenfeld (DE); Hans-Christian Strauch, Dormagen (DE); Hans Magg, Kurten (DE); Dieter Lohr, Uedem (DE)

Correspondence Address: BAYER CORPORATION, PATENT DEPARTMENT, 100 BAYER ROAD, PITTSBURGH, PA, 15205, US

(21) Appl. No.: 10/006,497

(22) Filed: Dec. 3, 2001

(30) Foreign Application Priority Data
Dec. 6, 2000 (DE) 10060474.9

(51) Int. Cl. C08K 3/00

(52) U.S. Cl. 524/521; 524/525; 524/502; 524/515

(57) ABSTRACT

The invention relates to a method of producing mixtures of polyvinyl chloride and polymers based on conjugated dienes and acrylonitrile, by mixing powdered polyvinyl chloride with latexes based on conjugated dienes and acrylonitrile and then coagulating the mixture. The method according to the present invention represents an inexpensive and environmentally friendly method of producing the mentioned mixtures, the physical behavior of the resulting mixtures being no different to that of corresponding mixtures produced by the dry blend method or the latex blend method.

### FIELD OF THE INVENTION

The invention relates to a method of producing mixtures of polyvinyl chloride and polymers based on conjugated dienes and acrylonitrile.

### BACKGROUND OF THE INVENTION

Mixtures of polyvinyl chloride and, for example, copolymers of acrylonitrile and butadiene (NBR rubbers) are known and are valued in the rubber-processing industry because vulcanates thereof exhibit very good ozone or weathering resistance, coupled with high resistance to swelling in oils or benzene and good flame resistance. In addition, the blends of nitrile rubber (NBR) with polyvinyl chloride (PVC) are distinguished by better processing properties as compared with pure nitrile rubber mixtures. Moreover, the vulcanates exhibit increased tensile strength and tear strength. Reference is made in this connection to corresponding comments in the “Handbuch für die Gummiindustrie” from Bayer AG, 2nd edition of 1991, page 90 ff.

Two different methods are employed in the rubber industry for producing the mentioned mixtures of NBR and PVC, the so-called dry blend method and the latex blend method.

In the dry blend method, the bales of NBR are comminuted and mixed with PVC powder by the batch method. The mixture is homogenized in a kneader or in a screw, the PVC component being distributed in the NBR phase to such an extent that no areas of PVC are discernible in the NBR phase. Gelling is then also referred to.

In the latex blend method, the NBR latex is blended with a corresponding PVC latex before being worked up to the solid. The mixture is then coagulated, gelled and thus worked up continuously to the solid product.

A disadvantage of the latex blend method is that the PVC latex that is used still contains a considerable amount of monomeric vinyl chloride. For reasons of environmental protection and safety in the workplace (with regard to vinyl chloride see: 1st Hazardous Substances Directive, 19th adaptation, 2nd Römpp Chemielexikon, Thieme Verlag), it is, therefore, desirable to use PVC components in which the content of monomeric vinyl chloride is less than 1 ppm. Moreover, the use of a PVC latex for producing the mentioned blends is less economical owing to the high water content of the latex, which has a negative effect on transport and on processing (removal of the aqueous phase).

Disadvantages of the dry blend method are, in particular, that the NBR and PVC components that are used must be distributed homogeneously in the blend, that the NBR and PVC components must be thoroughly distributed prior to the gelling, and that the bales of NBR that are used must be thoroughly comminuted beforehand. Those factors are all associated with a high technical outlay, so that the dry blend method is less economical than the latex blend method.

### SUMMARY OF THE INVENTION

The object of the present invention was to provide an inexpensive and environmentally friendly method of producing mixtures of polyvinyl chloride and polymers based on conjugated dienes and acrylonitrile, such method avoids the above-described disadvantages of the mixing methods hitherto employed in rubber technology.

### DETAILED DESCRIPTION OF THE INVENTION

Accordingly, the present invention provides a method of producing mixtures of polyvinyl chloride and polymers based on conjugated dienes and acrylonitrile, wherein the method is characterized in that powdered polyvinyl chloride is mixed with NBR latexes based on conjugated dienes and acrylonitrile, and the mixture is then coagulated.

It is important for the method according to the present invention that polyvinyl chloride in powdered form is blended with the latex based on conjugated dienes and acrylonitrile. According to the present invention, powdered polyvinyl chloride is to be understood as being homopolymers based on the emulsion or suspension or microsuspension process as well as graft copolymers and copolymers according to the suspension process having a mean particle diameter in the range from 5 to 200 μm and K values (DIN 53726 or ISO 1628) of from 40 to 90. Preference is given to powdered homopolymers based on the emulsion or, especially, the suspension process having mean particle diameters of from 40 to 150 μm and K values of from 55 to 75.

There is usually used in the method according to the present invention commercially available polyvinyl chloride having the typical residual vinyl chloride content (<1 ppm vinyl chloride), provided it meets the above-indicated specification.

There may be used as latexes based on conjugated dienes and acrylonitrile all latexes typical for NBR production that have a polymer content, by weight, in the range from 10 to 50 wt. %, with contents of from 15 to 30 wt. % being preferred.

The amount of conjugated dienes and acrylonitrile in the polymers to be used may vary within wide limits; for example, it is possible to use polymers in which the content of conjugated dienes is in the range from 40 to 90 wt. %, preferably from 55 to 75 wt. %, and the content of acrylonitrile is in the range from 10 to 60 wt. %, preferably from 25 to 45 wt. %.

Examples of conjugated dienes that come into consideration for the polymers that are to be used are especially 1,3-butadiene and isoprene as well as other conjugated dienes such as 2,3-dimethyl-1,3-butadiene, 1,3-pentadiene and piperylene, with 1,3-butadiene being preferred.

In addition to acrylonitrile, it is also possible to use its known derivatives, such as α-chloroacrylonitrile and/or methacrylonitrile.

Of course, in addition to the mentioned conjugated dienes and the acrylonitrile, it is also possible to use further monomers known to the person skilled in the art for constructing the polymers that are to be used. Mention may be made in this connection of, for example, α,β-unsaturated carboxylic acids and α,β-unsaturated carboxylic acid esters. Preference is given to fumaric acid, maleic acid, acrylic acid, methacrylic acid, as well as butyl acrylate and butyl methacrylate, as well as ethylhexyl acrylate and ethylhexyl methacrylate.

Furthermore, crosslinking polyfunctional monomers known to the person skilled in the art may be used for constructing the polymers that are to be used. Such monomers are especially di- and tri-functional monomers. Examples which may be mentioned here are divinylbenzene, diethylene glycol dimethacrylate and trimethylolpropane trimethylacrylate.

The additional monomers for construction of the polymers based on the mentioned conjugated dienes and the acrylonitriles may be present in amounts of from 0.1 to 40 wt. %, preferably from 1 to 30 wt. %, based on the total polymer.

The latexes based on conjugated dienes and acrylonitriles that are to be used according to the present invention, optionally, with addition of the additionally mentioned polymerizable monomers, are described in the specialist literature known to the person skilled in the art, as is their method of preparation (e.g. Ullmann's Encyclopedia of Industrial Chemistry, Vol. A23, p. 239-364).

By the process according to the present invention, mixtures of polyvinyl chloride and polymers based on conjugated dienes and acrylonitriles, optionally with addition of the additionally mentioned monomers, are produced in which the amount of polyvinyl chloride in the mixtures is in the range from 10 to 95 wt. %, preferably from 25 to 45 wt. %, and the amount of the described rubber polymers is from 90 to 5 wt. %, preferably from 55 to 75 wt. %.

Mixing of the two components may be carried out in many different mixing devices. Examples which may be mentioned are stirrer vessels of variable vessel geometry with single- and multi-shaft stirrers and different mixing tools as well as rotor-stator mixers, mixing by circulating by pumping with and without the use of rotor-stator dispersing machines or mixing nozzles, jet suction devices, injectors, tumbler mixers, planetary mixers, plough blade mixers with and without blade stirrers, preferably mixing in stirrer vessels or jet suction devices, injectors, guide beam mixers, especially mixing in stirrer vessels.

According to the present invention, mixing of the mentioned components takes place at temperatures in the range of approximately from 10 to 100° C., preferably at from 15 to 30° C.

It is, of course, possible to carry out mixing of the components used in the presence of stabilizers. Stabilizers, according to the present invention, can be substances and mixtures of substances conventionally employed for stabilizing PVC, such as, preferably organotin compounds, metal soaps, lead compounds and organic nitrogen compounds, with more preference being given to mixtures of calcium and zinc stearate.

The stabilizers are usually used in amounts of from 0.2 to 5 wt. %, preferably from 0.4 to 2 wt. %, based on the rubber PVC mixture.

The method according to the present invention may, for example, be carried out in such a manner that the latex based on conjugated dienes and acrylonitrile is placed in a vessel and the polyvinyl chloride in powdered form is mixed therewith, with intensive thorough mixing by means of stirrer vessels, until a homogeneous mixture of polyvinyl chloride and the mentioned polymers has formed.

In the method according to the present invention, after mixing of the powdered polyvinyl chloride with latexes based on conjugated dienes and acrylonitrile, the suspension so obtained is coagulated. To that end, known precipitating agents are added to the suspension in the conventional manner (see in this connection Ullmann's Encyclopedia of Industrial Chemistry, Vol. A23, p. 260 to 261).

There is obtained a mixture of polyvinyl chloride and the polymers based on conjugated dienes and acrylonitrile in solid form, which can be processed further in the conventional manner for the production of vulcanates of all kinds, for example, for use, in hoses.

It is surprising that it has been possible by the method according to the present invention to produce mixtures of polyvinyl chloride and polymers based on conjugated dienes and acrylonitrile simply by mixing powdered polyvinyl chloride with the mentioned latexes, since it was to be expected that, on stirring the PVC powder into the latex, coagulation of the latex would occur so that it would not be possible to obtain the desired homogeneous mixture of the two components. Furthermore, the analytical determination of the organic chloride content in the blend indicates that the PVC powder has been completely coagulated together with the NBR latex. There is no loss of PVC as a result of washing operations during the working-up process. Moreover, it was surprising that, under the mixing conditions, no separation of the components occurs and that mixtures are obtained that do not differ in terms of physical behaviour from the corresponding mixtures produced by the dry blend method or the latex blend method.

The invention is further illustrated but is not intended to be limited by the following examples in which all parts and percentages are by weight unless otherwise specified.

### EXAMPLE

With stirring, 30 parts of a suspension PVC powder having a K value of 71 (Solvin) and 1 part of a calcium-zinc stearate mixture (Ciba) are added to 70 parts of a Perbunan NT 2830 (Bayer AG) latex. Stirring is continued for a further one hour before the mixture is precipitated by addition of a calcium chloride solution at 70° C. The rubber is filtered off and washed with water. The rubber is then dried. Examination under a microscope shows uniform distribution of the PVC powder in the rubber, and chlorine determination yields the theoretically calculated Cl content, which confirms complete precipitation of the PVC powder with the rubber.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of producing mixtures of polyvinyl chloride and polymers based on conjugated dienes and acrylonitrile, comprising the steps of mixing powdered polyvinyl chloride with latexes based on conjugated dienes and acrylonitrile, and coagulating the mixture.

2. A method according to claim 1, wherein the powdered polyvinyl chloride is a polyvinyl chloride having a mean particle diameter in the range from 5 to 200 μm and K values (DIN 53726/ISO 1628) of from 40 to 90.

3. A method according to claim 1, wherein the latexes based on conjugated dienes and acrylonitrile are latexes having a polymer, by weight content, in the range from 10 to 50%.

4. A method according to claim 1, wherein the polymers based on conjugated dienes and acrylonitrile are polymers in which the content of conjugated dienes is in the range from 40 to 90 wt. % and the content of acrylonitrile is in the range from 10 to 60 wt. %.

5. A method according to claim 1, wherein powdered polyvinyl chloride is mixed with the latexes at temperatures in the range from 10° C. to 100° C.
